(19) United States
(12) Patent Application Publication
(10) Pub. No.: US 2016/0364799 A1
(43) Pub. Date: Dec. 15, 2016

(54) SYSTEM AND METHOD FOR DETERMINING A TRADABLE VALUE

(71) Applicant: Chicago Board Options Exchange, Incorporated, Chicago, IL (US)

(72) Inventor: Dennis M. O'Callahan, Evanston, IL (US)

(73) Assignee: Chicago Board Options Exchange, Incorporated, Chicago, IL (US)

(21) Appl. No.: 15/066,712

(22) Filed: Mar. 10, 2016

Related U.S. Application Data
(63) Continuation of application No. PCT/US2014/055213, filed on Sep. 11, 2014.
(60) Provisional application No. 61/876,669, filed on Sep. 11, 2013.
(60) Provisional application No. 61/951,368, filed on Mar. 11, 2014.

(51) Int. Cl. G06Q 40/04; G06Q 40/06

(52) U.S. Cl. CPC G06Q 40/04; G06Q 40/06

(57) ABSTRACT

Embodiments include systems and methods for determining a tradable value, such as an SOQ and/or spot index for one or more financial products. The computer-implemented methods include receiving, by a computing device, a data feed having data fields that correspond to messages, orders, quotes, and other financial exchange specific data points. The computing device may be configured to select one or more input sets from the received data feed and determine a score for one or more of the selected input sets. Once one or more input sets are selected, the computing device may calculate an SOQ and/or spot index based on the selected input set(s) and disseminate the calculated SOQ and/or spot index to one or more market entities, such as a clearing corporation.

### CROSS-REFERENCE TO RELATED APPLICATIONS

The present application is a continuation of PCT/US2014/055213, filed Sep. 11, 2014 which claims the benefit of U.S. Provisional Application No. 61/876,669, filed Sep. 11, 2013, and claims the benefit of U.S. Provisional Application No. 61/951,368, filed Mar. 11, 2014, wherein the entirety of each of the above-identified applications is hereby incorporated herein by reference.

### BACKGROUND

A derivative is a financial security whose value is based, at least in part, on a value or characteristic of an underlying asset. Two exemplary and well known derivatives are options and futures. An option is a contract that gives the contract holder a right, but not an obligation, to buy or sell an underlying asset at a specific price on or before a certain date. Generally, a party who purchases an option is referred to as the holder of the option and a party who sells an option is referred to as the writer of the option. For example, options can be based on stock indices, interest rates, futures contracts, and other derivatives.

There are generally two types of options: call and put options. A holder of a call option receives a right to purchase an underlying asset at a specific price, i.e., the “strike price.” If the holder exercises the call option, the writer is obligated to deliver the underlying asset to the holder at the strike price. Alternatively, the holder of a put option receives a right to sell an underlying asset at a strike price. If the holder exercises the put option, the writer is obligated to purchase the underlying asset at the agreed upon strike price. When settlement includes the transfer of an underlying asset, the settlement is often referred to as a physical settlement or an in kind settlement.

Put or call options may also be “cash settled.” That is, rather than transferring the underlying asset, a cash payment is made to settle the contract. For example, using cash settlement, a holder of an index call option receives the right to “purchase” not the index itself, but rather a cash amount based on the value of the index multiplied by a multiplier, e.g., $100. For example, if a holder of an index call option exercises the option, the writer of the option must pay the holder the difference between the current value of the underlying index and the strike price, multiplied by the multiplier. In settling index option contracts, a special opening quotation (SOQ) is calculated, and the settlement of the contracts are based thereon. The value of the underlying asset at a specific time outside of settlement is the spot price.

Modern financial exchange trading systems that facilitate the trading of financial products (e.g., exchange listed options) are complicated specialized networks composed of special purpose computer hardware and proprietary exchange software. These systems are capable of performing the necessary functions of a financial exchange. Further, these systems are designed, implemented, and continuously upgraded through new computer hardware and software to operate with enhanced stability and lower latency. Through enhanced stability and lower latency, financial exchanges are able to provide a better trading facility while simultaneously minimizing possible risk to the financial markets.

With the financial markets' adoption of exchange trading systems has come the rapid proliferation of financial trading data. This proliferation is due, in part, to the high number of trading messages (e.g., bids, offers, quotes, orders, and trading instructions) that are received and processed by exchange trading systems. The storage and fast accurate access of this data are important considerations of the modern financial exchange trading system. This is particularly true as financial products that trade on financial exchange trading systems increase in complexity and are at least in part based on financial trading data generated and stored in the financial exchange trading system. For example, indexes may use exchange generated data in calculating spot and SOQ values. With the increased index and financial trading system complexity comes an increased possibility that an SOQ or spot value could be calculated using the wrong data. Therefore, there exists a need for improvements to financial exchange trading systems in order to ensure the proper selection and retrieval of financial data that is then used to calculate both spot and SOQ index values.

### SUMMARY

Example embodiments may describe calculating a tradable value, such as an SOQ and/or spot index, for one or more financial products. In particular, in one example, a computer-implemented method is disclosed that involves receiving, by a computing device, a data feed. The data feed may include numerous data fields (e.g., a product symbol, an opening price, a strike price, an expiration date, etc.) that correspond to messages, orders, quotes, and other financial exchange specific data points. The computing device may be configured to select one or more input sets from the received data feed and determine a score for one or more of the selected input sets. The process of determining a score for the one or more of the selected input sets may be performed in a variety of ways. Once one or more input sets are selected, the computing device may calculate an SOQ and/or spot index based on the selected input set(s) and disseminate the calculated SOQ and/or spot index to one or more market entities, such as a clearing corporation.

In another embodiment, a system may be configured to determine settlement values of derivative investment instruments representative of a state of market volatility. The system may include a communication interface configured for communication with at least external one data source remotely located from the system via a network. The at least one data storage device can store data received via the communication interface, wherein the received data may correspond to price and expiration information for a plurality of financial instruments determined as suitable as underlying assets for derivative investment instruments representative of the state of market volatility. The plurality of financial instruments may define one or more input sets, wherein each input set comprises options contracts having a same underlying asset, different expiration dates, and/or different expiration intervals. The system may also include an order matching engine having a processor configured to receive a plurality of contra-position bids and offers and pair up the received contra-position bids and offers to complete trades between the paired received contra-position bids and offers.

The system may further include a settlement value processor in communication with the at least one data storage device and the order matching engine and a program logic memory in communication with the settlement value processor and storing program instructions, the settlement value processor may be operative to execute the program instructions to: receive a plurality of input sets from the at least one data storage device or the order matching engine; select a portion of the plurality of input sets based on a plurality of selection criteria, wherein one of the plurality of selection criteria comprises option contracts having expiration dates less than 30 days from a current day; and generate a settlement value for the derivative investment instrument representative of the state of market volatility according to the settlement calculation, and transmit a settlement value calculated according to the settlement calculation relation to a remote server. In embodiments, the settlement calculation may be:

$${σ}^{2} = \frac{2}{T} {\sum }_{i} \frac{Δ {K}_{i}}{{K}_{i}^{2}} {e}^{RT} Q ( {K}_{i} ) - {\frac{1}{T} [ \frac{F}{{K}_{0}} - 1 ]}^{2}$$

### Where:

T is a time to expiration;

F is a forward index level;

Kᵢ is a strike price of i^{th} out-of-the-money option—a call if Kᵢ>F and a put if Kᵢ<F;

ΔKᵢ is an interval between strike prices: ΔKᵢ is the interval between strike prices—half the distance between the strike on either side of Kᵢ:

$$Δ {K}_{i} = \frac{{K}_{i + 1} - {K}_{i - 1}}{2}$$

wherein ΔK for a lowest strike is a difference between the lowest strike and a next higher strike; likewise, ΔK for a highest strike is a difference between the highest strike and a next lower strike;

K₀ is a first strike below the forward index level, F;

R is a risk-free interest rate to expiration; and

Q(Kᵢ) is a midpoint of a bid-ask spread for each option with strike Kᵢ.

Also disclosed herein are structures configured to facilitate implementation of the disclosed methods. One embodiment may take the form of a computing device (e.g., a communication device, computing system, etc.) that includes a communication interface, a processor, data storage, and program instructions executable by the processor for carrying out the functions described herein. Another embodiment may take the form of a non-transitory computer-readable medium having instructions stored thereon for carrying out some or all of the functions described herein.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

Various embodiments are described herein with reference to the following drawings, in which like numerals denote like entities, and in which:

FIG. 1 is a simplified block diagram that illustrates a trading system in which embodiments of the disclosed methods and entities can be implemented;

FIG. 2 is a functional block diagram that illustrates a computing device used in a trading platform;

FIG. 3 is a block diagram that illustrates a data feed and components used in a computing device;

FIG. 4 is a flow diagram that depicts functions that may be included in the trading platform to facilitate implementation of the methods described herein;

FIG. 5 is a flow diagram that depicts an embodiment of the selection function of FIG. 4;

FIG. 6 is a flow diagram that depicts an additional embodiment of the selection function of FIG. 4; and

FIG. 7 is a timeline that depicts contract expiration dates.

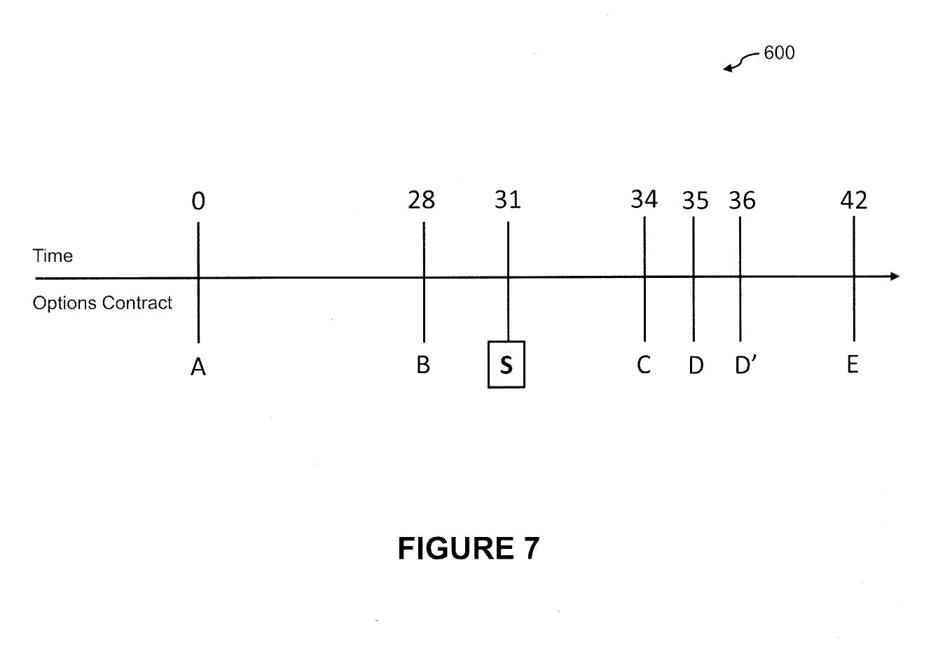

### DETAILED DESCRIPTION

In the following detailed description, reference is made to the accompanying figures, which form a part hereof. It should be understood, however, that the arrangements described herein are set forth as examples only. As such, those skilled in the art will appreciate that other arrangements and elements (e.g., machines, interfaces, functions, orders of functions, etc.) can be used instead or in addition. Further, many of the elements described herein are functional entities that may be implemented as discrete or distributed components or in conjunction with other components, and in any suitable combination and location. Various functions described herein as being performed by one or more entities may be carried out by hardware, firmware or software logic. For instance, various functions described herein may be carried out by a processor executing instructions written in any suitable programming language and stored in memory.

Embodiments described herein are directed to methods and systems for calculating an SOQ and/or a spot index based on options; however, other values may be calculated using the same or similar methods and systems described herein. As described herein, the methods and systems may be integrated into one or more computerized systems. The computerized systems may include financial trading systems that have been or are currently being used by financial exchanges, such as the Chicago Board Options Exchange Incorporated. The computerized systems may also include non-financial exchange systems that may be separate from the financial trading systems. The financial exchange systems and non-financial exchange systems may be utilized alone or in combination with one another to implement one or more functions described herein. That said, all embodiments will require specialized systems that will typically be a combination of computer hardware and proprietary software designed and implemented for the purpose of carrying out electronic financial trading, financial index calculation, or some combination thereof.

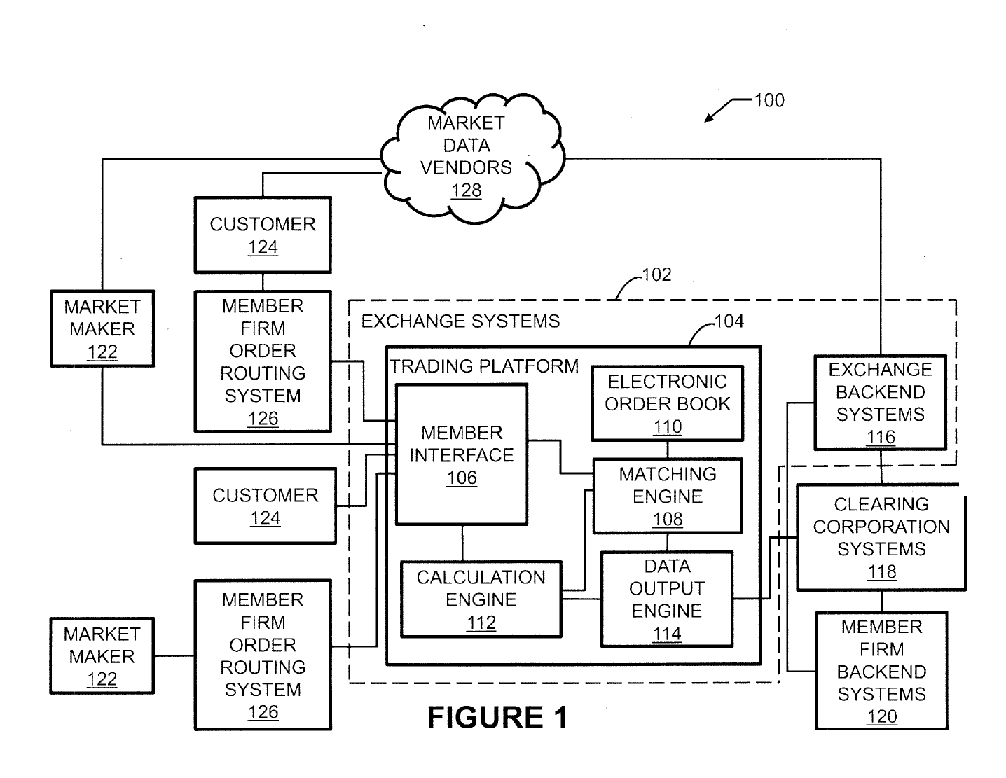

FIG. 1 is a simplified block diagram that illustrates a financial trading system 100 in which embodiments of the disclosed methods and entities can be implemented. Each of the blocks of FIG. 1 can be implemented using a combination of computer hardware and software designed and implemented to achieve the functionality of each of the blocks. For example, member interface 106, as described in further detail below, may include special purpose software configured to accept financial exchange messages through a communication port of a computer server connected to an electronic communication network (e.g., LAN or Internet) by one or more pieces of computer networking equipment (e.g., a switch) configured through software to receive and route financial exchange messages to the appropriate destinations with the financial trading system 100.

Financial trading system 100 includes financial exchange components, as well as components that may be operated by non-exchange entities that access the financial exchange. Examples of financial exchange components are shown within the dashed lines 102. Components outside the dashed lines 102 are components that may be operated by non-exchange entities. Electronic communications within financial trading system 100 may be achieved using a variety of known mediums, including: local area networks (LANs), wide area networks (WANs), the Internet, etc.

The illustrated exchange components of the financial trading system 100 include a computer implemented trading platform 104 (that includes, but is not limited to, a member interface 106, a matching engine 108, an electronic order book 110, a calculation engine 112, and a data output engine 114) and computer implemented exchange backend systems 116. Member interface 106 may provide an electronic interface for receiving trading messages (e.g., bids, offers, quotes, orders, and trading instructions) from one or more computing devices associated with one or more traders or other entities transacting business at the financial exchange. Member interface 106 may be implemented as a graphical user interface (GUI) and may include one or more software components operating on a computing device configured to perform trading functionality.

Member interface 106 may also be implemented to analyze electronic trading messages for proper format and information. If member interface 106 (or another financial exchange component) deems a trading message to have proper format and information, member interface 106 may route the eligible electronic trading messages to the appropriate matching engine 108 where the eligible trading message may be matched to a contra-position.

In embodiments, trading platform 104 may include an application programming interface (API), which may communicate with the member interface 106 and/or other components of exchange systems 102. The API may include programming instructions and standards that allow one or more entities (e.g., market maker 122, customer 124, member firm order routing system 126, etc.) to interface with the trading platform 104 via specially programmed computer code. For example, market maker 122 may program software to connect to an API at trading platform 104. Once connected, market maker 122 may enter quotes into a specially programmed computer or have programs generate computer quotes based on determined strategies. The entered or otherwise generated quotes can be sent to the trading platform 104 via the API. Once received, the API can route the received quotes to a processor associated with member interface 106 where a determination can be made as to whether the quotes are eligible for execution. Eligible quotes can be sent to matching engine 108. Due to the large number of trading messages that are received every second, the API and/or member interface 106 should be configured to quickly and accurately process large amounts of data.

In some embodiments, trading messages received via member interface 106 (or the API) may be communicated to matching engine 108 and/or calculation engine 112 via a data feed. In embodiments, data in the data feed may be categorized or otherwise grouped based on one or more attributes that are associated with a financial product. The attributes may include, for example, a product symbol, an opening price, a strike price, an expiration date, a quote, originator of the order or quote, a class, a bid, an ask, or any number of other attributes that can be used to group trading message data. Data having one or more similar attributes may be combined to form an input set. The formation of an input set, attribute grouping, or other categorization of data in the data feed may be performed by a processor at trading platform 104. The input sets may include all or part of the data in one or more trading messages in the data feed. In some instances, the input sets may be formed by matching engine 108, while other instances may include the input sets being formed by calculation engine 112. Other instances also exist.

Matching engine 108 may provide an electronic mechanism for matching contra-position bids and offers that are submitted to the financial exchange by traders or other entities transacting business at the financial exchange. While financial trading system 100 shows a single matching engine 108, multiple matching engines may be included in a trading platform 104. Multiple matching engines may work independently or cooperatively depending on various factors related to the business of the financial exchange. For example, different exchange traded products (e.g., stocks, options, futures, etc.) may utilize different matching engines. The matching engine 108 may execute trades by pairing contra orders. In some examples, the non-marketable orders may be placed in an electronic order book (EBOOK) 110. An electric order book 110 may be implemented using known computer hardware in combination with a database product. Orders in EBOOK 110 may rest until they can be matched to a contra position. Resting orders may or may not be sent to calculation engine 112 for inclusion in the SOQ or spot calculation.

Matching engine 108 may update the EBOOK 110 based on executed transactions. After a trade is executed, matching engine 108 can send information related to the executed trade to the data output engine 114. The data output engine 114 may send the received information to exchange backend systems 116, which may be used in the process of settling trades that have been executed at the financial exchange. Further, data output engine 114 may send information related to the executed trade to one or more member firm backend systems 120. Member firm backend systems 120 may record or otherwise track an entity's executed transactions and/or those transactions that have yet to be executed.

Matching engine 108 may also include an electronic mechanism for communicating all or part of the trading messages to calculation engine 112. In some embodiments, matching engine 108 may provide the trading messages to calculation engine 112 via the data feed. The data feed may be provided to calculation engine 112 continuously or periodically. For example, in some embodiments, matching engine 108 may accumulate contra bids and offers that have been matched and send the accumulated matched contra bids and offers in the data feed to calculation engine 112 every one, five, or fifteen seconds. In other examples, matching engine 108 can send the matched contra bids and offers to calculation engine 112. In yet another example, bids and orders can be sent from member interface 106 to calculation engine 112 without first being matched using matching engine 108. Other examples are also contemplated.

Calculation engine 112 may receive the data feed and perform one or more calculations to facilitate trading. The calculations include, but are not limited to, the calculation of an SOQ and/or spot index value. The process of performing such calculations may include an identification of what calculation is being performed, the selection of data for purposes of performing the calculation, and the performance of one or more computations by calculation engine 112. Calculations (such as the calculation of an SOQ and/or spot index value) performed by calculation engine 112 may be validated or otherwise processed for error handling by an error handling module at calculation engine 112 and sent to data output engine 114. In some embodiments, calculation engine 112 may communicate with member interface 106, matching engine 108, or another trading platform component to obtain additional data to perform the calculation, validate received data, etc.

For example, calculation engine 112 may receive the data feed from matching engine 108 via a communication channel. Calculation engine 112 may identify or receive an identifier indicating what calculation is to be performed. In one instance, calculation engine 112 may perform the identification based on a clock or timer and rules that specify what calculation to perform at what time(s). In another instance, calculation engine 112 may include software modules that are specially programmed to perform specific calculations such that each module performs its respective calculation based on data received via the data feed or via lookups to a scheduled tasks table. Each module may be specially programmed to perform one or more defined calculations at a specified interval based on one or more rules. Once the calculation is identified, calculation engine 112 can select data in the data feed for purposes of performing the calculation.

In embodiments, when calculating the SOQ, calculation engine 112 may receive a defined input set or select an input set input set based on (i) if there is a valid expiration date in existence; (ii) information related to the liquidity of the financial product; (iii) quote width of the financial product; (iv) strike range span; (v) number of series listed for the financial product when the financial product is a derivative; (vi) information related to open interest in the financial product; (vii) information related to the robustness and/or quality of information available for the financial product; (viii) originator of the order or quote, (ix) etc. In another instance, when calculating a spot value, calculation engine 112 may receive defined input sets or select multiple input sets based on one or more factors used to select an input set for calculating the SOQ. One or more of the input sets used to calculate the SOQ may also be used to calculate the spot value. However, the weight attributed to one or more of the selected input sets may vary based on the method used to calculate the SOQ and/or spot value.

For example, the data feed may include one or more assets or unique symbols tied to the same class underlying an option. Each of the one or more classes may be represented as an input set(s) to calculation engine 112. Calculation engine 112 may select which, if any, of the input sets should be used to calculate the SOQ. Calculation engine 112 may make this selection by determining whether one or more of the input sets are designated or defined for use in calculating the SOQ. If so, calculation engine 112 may use one or more of the designated or defined input sets to calculate the SOQ. For instance, the data feed may include data having an indicator that identifies if the data associated with the indicator should be included in the SOQ or spot index calculation. This may occur, for example, when the expiration date of the trading message in the data feed meets a certain criteria and/or when the product symbol is identified in the trade message. Other examples also exist.

If no input sets are defined, or if the calculation allows for input sets in addition to the defined inputs, calculation engine 112 may select the input sets based on one or more factors. These factors may include, but are not limited to: (i) if there is a valid expiration date in existence; (ii) information related to the liquidity of the financial product; (iii) quote width of the financial product; (iv) strike range span; (v) number of series listed for the financial product when the financial product is a derivative; (vi) information related to open interest in the financial product; (vii) information related to the robustness and/or quality of information available for the financial product; (viii) originator of the order or quote, (ix) etc. The financial product may include any financially tradable product including, but not limited to, derivative contracts.

In some examples, calculation engine 112 may apply a weight to one or more of the above noted factors. The weight may be static or vary between implementations and input sets. Calculation engine 112 may use one or more of the weights to identify which input set(s) to use to calculate the SOQ, spot index, or other value. For example, when selecting input sets from the data feed, calculation engine 112 may encounter quotes having expiration dates “X,” “Y,” and “Z.” However, for purposes of calculating the spot index, calculation engine 112 may only need quotes expiring on two expiration dates. Calculation engine 112 can determine what two expiration dates should be used when calculating the spot index (e.g., via a calendar lookup function) and assign weights to the input sets(s) associated with the determined dates.

For instance, if the spot index is being calculated with input sets having options that expire in more than 23 days but less than 37 days then calculation engine 112 may select those input sets having options with expiration dates that fall within such range. Such selection may be performed, at least in part, by giving a higher weight or score to those input sets having options with expiration dates falling within the defined range than those falling outside of the defined range.

In another example, the calculation engine 112 may select two or more input sets to calculate a spot index. One or more of the input sets may be designed, defined, or otherwise selected based on one or more of the factors described herein. In some embodiments, calculation engine 112 may further employ one or more additional methodologies to identify input sets that optimize spot indexes calculated with options prices by limiting, if not eliminating, the need to extrapolate data when calculating the spot index.

For instance, the calculation engine 112 may identify input sets associated with near term options having a time to expiration occurring before the point in time for which the spot index is being calculated. In embodiments, the near term options may have a time to expiration that is closest of all the input sets to the point in time for which the spot index is being calculated. This embodiment may further include next term options having a time to expiration that is closest of all the input sets to the point in time for which the spot index is being calculated. By identifying input sets that include the near term options and next term options that are closest to the point in time for which the spot index is being calculated, the calculation engine 112 may utilize an interpolation function to calculate the spot index at the point in time.

In instances where calculation engine 112 is unable to utilize interpolation (e.g., due to incomplete input data, limitations on what input sets can be used to calculate the spot index, etc.) calculation engine 112 may identify and use the next closest near term options and/or next term options that are valid to calculate the spot index. The process of identifying the next closest near term options and/or next term options that are valid may include a determination of what combination of near term option(s) and next term option(s) result in the least amount of extrapolation when calculating the spot index. When determining the least amount of extrapolation, calculation engine 112 may account for: (i) time between the near term options and next term options; (ii) option contracts included in the near term options and/or next term options; (iii) limitations on how or what the near term options and/or next term options may be used; (iv) the day of the week that the near term options and/or next term options expire; (v) etc. In some examples, one or more of the near term option(s) and/or next term option(s) may be invalid or otherwise non-viable input sets. In such examples, calculation engine 112 may determine the combination of input sets that are valid and allow for the least amount of extrapolation using valid input sets.

The selection, weighting, and calculation process described herein may be performed on short time intervals (e.g., every 1, 5, 10, or 15 seconds). Each calculation is based on data received and accessed subsequent to the prior calculation, for this reason the systems performing the functionality disclosed herein generally will be designed to minimize data latency within the system. The limited time to perform the calculation, the amount of data, and the complexities of the calculation make it important to accurately and timely calculate the SOQ, spot, and other values.

Calculation engine 112 may store the calculated value in data storage and/or send the calculated value to data output engine 114 for dissemination to clearing corporation systems 118. In some examples, the data output engine 114 may also or optionally disseminate the calculated value to other financial entities, market participants, etc.

The non-exchange components of financial trading system 100 can include clearing corporation systems 118 and member firm backend systems 120; however, additional non-exchange components are also contemplated. Clearing corporation systems 118 may be used in the process of settling trades that have been executed at the financial exchange. An example of a clearing corporation is The Options Clearing Corporation, which is an equity derivatives clearing organization. In some examples, the data output engine 114 may send a calculated SOQ, spot index, or other value to the clearing corporation systems 118 for use in settling one or more transactions. Member firm backend systems 120 may be used by the entities conducting business at the financial exchange to receive settlement information regarding their transactions. The received settlement information, which may include the SOQ or other value used in the settlement process, may be transmitted from exchange system 102 (e.g., data output engine 114) to member firm backend systems 120 via a communication mechanism. In embodiments, member firm backend systems 120 may include a storage device for storing the settlement information, a display device for displaying the settlement information, and/or any number of other components that can be used to facilitate the use of the settlement information.

The computer implemented trading platform 104 can be accessed in a variety of ways by entities conducting business at the financial exchange. For example, market makers may access computer implemented trading platform 104 through market maker computers 122 that are in electronic communication with the member interface 106 (or an API). Utilizing the market maker computers 122, electronic trading messages (e.g., bids, offers, quotes, orders, trading instructions) may be sent to the computer implemented trading platform 104. Alternatively, the electronic trading messages may be routed through a member firm order routing system 126. The trading messages may be routed to calculation engine 112 for calculation of the SOQ, spot index, or other value. The trading messages may include instructions for trading simple and/or complex orders. A simple order may include a single leg, while a complex order may include multiple legs that may be completed for a net price. One or more of the legs in the order may be for an index with a SOQ, spot index value, or other value that is determined using calculation engine 112 as described herein.

In further embodiments, a non-member entity wanting to transact business at the financial exchange can enter the non-member entity's trading instructions using a customer computer 124. Customer computer 124 may include one or more devices, such as a cellular telephone, smartphone, personal computer, laptop computer, tablet computer, personal digital assistant (PDA), or other device now known or later developed. The non-entity entered trading instructions may be routed through a member firm order routing system 126, which may transmit the electronic trading instructions to the member interface 106 (or an API). The trading instructions may be used to purchase one or more financial products whose value is determined using calculation engine 112.

The exchange backend systems 116 may perform a number of functions. For example, exchange backend systems 116 may perform operations related to contract definition and listing data. Additionally, exchange backend systems 116 may perform operations including one or more of (i) transmitting information regarding orders (including, but not limited to orders relating to index-based derivatives) to market data vendors 128; (ii) performing operations related to the performance of financial product upon which derivatives are based; (iii) determining appropriate contract settlement values; (iv) supplying final settlement data to the clearing corporation systems 118 and the member firm backend systems 120; (v) etc. In some examples, exchange backend system 116 may include one or more rules accessible by the calculation engine 112 and used to calculate the SOQ, spot index, or other value.

In some embodiments, calculation and settlement of derivatives may be handled by exchange backend systems 116, which may be one or more stand-alone or networked computers in communication with market data vendors 128 and/or one or more exchange system 102 components. The calculation of settlement values of index-based derivatives may be automatically triggered based on determined expiration dates of the underlying asset(s) of the expiring index-based derivative. Cash values of an index-based-derivative may be automatically calculated at regular intervals. For example, exchange backend systems 116 may automatically calculate cash values and disseminate those numbers every 1, 5, 10, or 15 seconds. For some financial products, the disseminated cash values may be determined by calculation engine 112 as described herein.

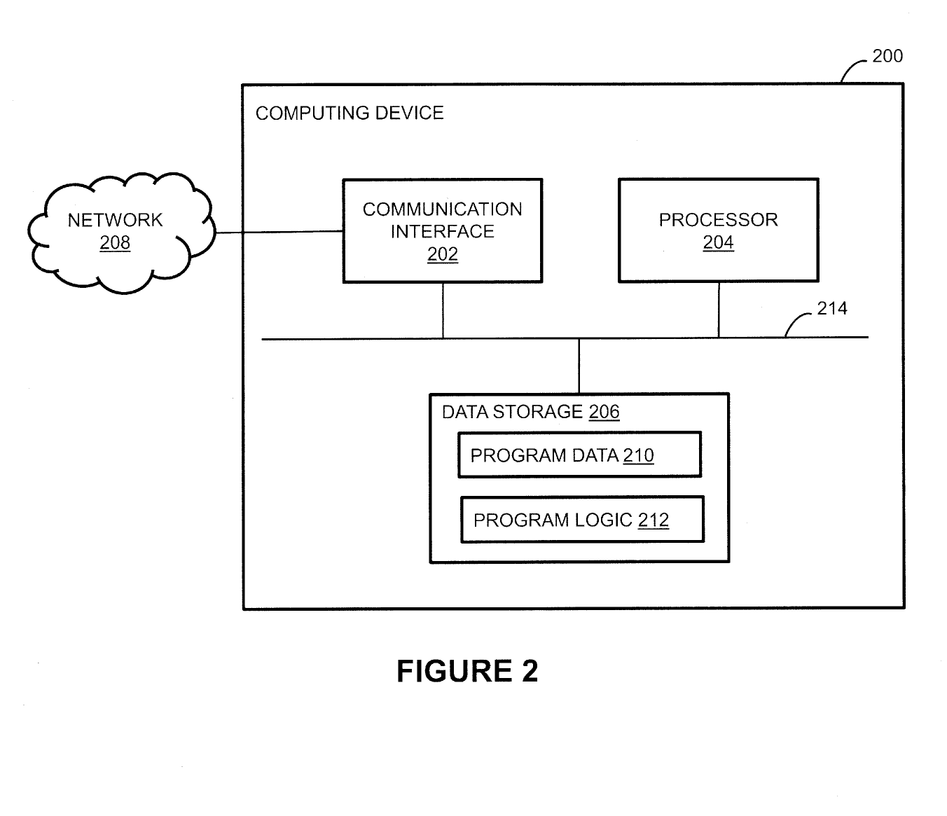

FIG. 2 is a functional block diagram that illustrates a computing device 200 used in a trading platform 104 or exchange backend systems 116 such as illustrated in FIG. 1 in accordance with embodiments described herein. Computing device 200 may take a variety of forms. For example, computing device 200 may comprise or be arranged as a calculation engine (such as calculation engine 112 in FIG. 1). As another example, computing device 200 may comprise or be arranged as a server, a computer, or other device or processing component that is now known or later developed, configured using proprietary software designed and implemented to achieve the functionality described herein.

As shown, computing device 200 may include a communication interface 202, a processor 204, and a data storage 206, all of which may be communicatively linked together by a system bus, network, or one or more other connection mechanisms 214. Although not shown, computing device 200 may also include other components, such as external storage, an input device operative to interact with the computing device, etc. It should also be understood that the configuration or functionality of computing device 200 may be distributed or subdivided between a plurality of entities, such as multiple computing devices. Further, it should be understood that some of the functions described herein may be carried out by an entity other than computing device 200.

In computing device 200, the communication interface 202 may comprise one or more structures, and associated equipment, for receiving data from one or more sources and distributing data to a group of one or more destinations. Communication interface 202 may be configured to receive input set data from one or more entities (such as matching engine 108 in FIG. 1) and store all or part of the input set data in data storage 206. Communication interface 202 may also be configured to communicate all or part of the input set data to data output engine 114 once the input sets are stored or otherwise processed.

Communication interface 202 may be configured to connect with a network 208, external media, a display, or any other components that may be present in a trading system (such as financial trading system 100 in FIG. 1). The connection with the network 208 (and/or components thereof) may be wired connection, a wireless connection, or combinations thereof. For example, the connection may be a physical connection, such as a wired Ethernet connection. In another example, the connection may be a wireless connection, such as a cellular telephone network, an 802.11, 802.16, 802.20 controls or components, a WiMax network, or any other type of network. Further, network 208 may be a public network, such as the Internet, a private network, such as an intranet, or combinations thereof, and may utilize a variety of networking protocols now available or later developed including, but not limited to TCP/IP based networking protocols.

Processor 204 may comprise one or more processors, such as general-purpose processors (e.g., a microprocessor), special-purpose processors (e.g., an application-specific integrated circuit (ASIC) or digital-signal processor (DSP)), programmable-logic devices (e.g., a field programmable gate array (FPGA)), or any other processor components now known or later developed. Processor 204 may carry out one or more instructions using one or more arithmetic, logical, and/or input/output operations. Though processor 204 is illustrated as a single component, processor 204 may be integrated in whole or in part with other components of computing device 200.

Data storage 206 may be a main memory, a static memory, or a dynamic memory. Data storage 206 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media, organic storage components, and the like. In one case, data storage 206 may include a cache or random access memory for the processor 204. Alternatively or in addition, data storage 206 may be separate from the processor 204, such as a cache memory of a processor, the system memory, or other memory. Data storage 206 may be an external storage device or database for storing data. Examples may include a hard drive, compact disc (“CD”), digital video disc (“DVD”), memory card, memory stick, universal serial bus (“USB”) memory device, or any other device operative to store data.

As further shown, data storage 206 may include program data 210 and/or program logic 212. Program data 212 may include one or more types of data suitable for a given implementation. For example, program data 212 may include data (such as input sets) that may be stored in memory. Program logic 210 may include, for example, machine language instructions executable by processor 204 to carry out various functions, such as the functionality of the methods and systems described herein. In some examples, the functions, acts or tasks may be independent of the particular type of instructions sets, storage media, processor or processing strategy and may be performed by software, hardware, integrated circuits, firm-ware, micro-code and the like, operating alone or in combination. Processing strategies may include multiprocessing, multitasking, parallel processing and the like.

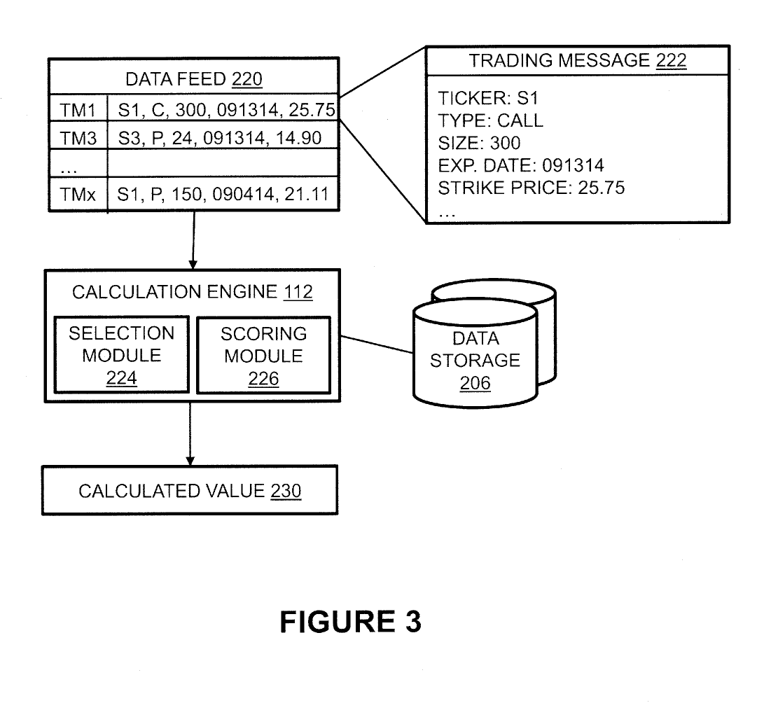

FIG. 3 is a block diagram that illustrates a data feed and example components used in a computing device. In particular, FIG. 3 illustrates a data feed 220 having a plurality of trading messages (e.g., TM1, TM3, TMx). The trading messages may be sent to trading system 100 by an entity such as market maker 122, customer 124, member firm order routing system 126 and stored in data storage 206. The format of the trading messages may vary based on what the trading system 100 configured to accept. In one example, an entity may send a trading message to exchange system 102 using the FIX protocol language and the messaging standards associated therewith. In another example, a proprietary data format may be defined for purposes of sending and/or receiving trading messages.

Various types of information may be communicated via trading messages. Example information may include the underlying index, a ticker symbol, a contract type (e.g., call or put option contracts), an expiration date, a strike price, an exercise style (e.g., American or European, AM or PM settled, etc.), a settlement value, and/or other information. Trading messages may be communicated to calculation engine 112 via a communication mechanism (such as communication mechanism 214 in FIG. 2).

Upon receipt of the trading message, calculation engine 112 may determine what calculation is being performed and select data for purposes of performing the determined calculation. In embodiments, the selection may be performed by a selection module 224. Selection module 224 may select data from within data feed 220 that has common attributes and group the selected data into one or more input sets. The input sets may be stored in data storage 206. For example, selection module 224 may receive data feed 220 and form an input set by grouping trading messages that have the same expiration date. In another example, selection module 224 may form an input set based on the ticker symbol. In yet another example, selection module 224 may form an input set based on multiple factors, such as the same expiration date and ticker symbol. In a further example, selection module may communicate with one or more other components in trading platform 104 to identify market volatility and form input sets based on the identified market volatility. Other examples are also contemplated.

Selection module 224 may perform one or more iterations in identifying input sets from data feed 220. For instance, in a first iteration, selection module 224 may parse data in data feed 220 to select trading messages having a time to expiration that is more than 23 days but less than 37 days in the future. In a second iteration, selection module 224 may parse data feed 220 (or an input set already parsed from data feed 220) based on a ticker symbol to identify those trading messages having a 9-day, 30-day, quarterly, or other duration of time prior to expiration. Selection module 224 may continue to parse data feed 220 or portions thereof to identify potential input sets for use in calculating the SOQ, spot index, or other value. In another instance, individual quotes or buy and sell orders may be captured within a defined time interval, with the first, last, etc. quote for a specific series used in the index calculation.

Scoring module 226 may score or otherwise weight one or more of the selected input sets. The scoring process may be based on a number of factors. For example, scoring module 226 may assign scores to one or more inputs sets based on the fitness of an input set for inclusion in a calculation. In another example, scores may be based on defined criteria or thresholds wherein a first score is assigned to input sets having data falling within a first threshold and a second score is assigned to input sets having data falling within a second threshold. In yet another example, scores may be defined or otherwise assigned based on one or more rules that are programmatically defined by an entity having control over exchange systems 102.

In yet a further example, scores may be assigned dynamically. Dynamic scoring may include, for instance, adjusting one or more scores for an input set based on the actual or perceived importance of the input set at a specific time. For instance, when calculating the spot index, the score associated with input sets having a specific time to expiration may increase as the expiration date approaches. Similarly, scores associated with input sets having a liquidity exceeding a specified threshold may dynamically decrease as the time to expiration decreases. Additional or alternative dynamic scoring is also contemplated. One or more scores associated in an input set may be stored in data storage 206 and later accessed by calculation engine 112 or another component of exchange system 102.

Selection module 224 and scoring module 226 may work together to identify and score potential input sets. Once scored, selection module 224, scoring module 226, or another module at calculation engine 112 may identify what input sets have the best or otherwise most viable scores for purposes of performing a calculation. Calculation engine 112 may use the identified input sets in performing the calculation and output the calculated value 230 to data output engine 114.

As an example, when calculating the spot index, calculation engine 112 may receive data feed 220 and selection module 224 may identify an input set having trading messages expiring within a specified range of dates. Selection module 224 may further parse data from within the identified input set based on ticker symbol so as to identify potential candidates for determining near and next term options. Scoring module 226 may score the input sets by assigning a higher weight to those input sets that are both within the range of dates and also have a ticker symbol that indicates a specific expiration (such as the third Friday of the month, AM or PM settled, etc.). Calculation engine 112 may perform a viability check on the input sets having the highest scores to determine whether the input sets are appropriate for inclusion in the spot index calculation. If not, calculation engine 112 may select the input set(s) with the next highest viable scores. If the input set(s) are viable, calculation engine 112 may perform the spot calculation (as described elsewhere herein) and disseminate the calculated value 230 to data output engine 114.

Though described in the context of the spot index calculation, it should be understood that calculation engine 112 may perform the selection, scoring, and calculation process described herein in a variety of contexts including but not limited to the calculation of the SOQ.

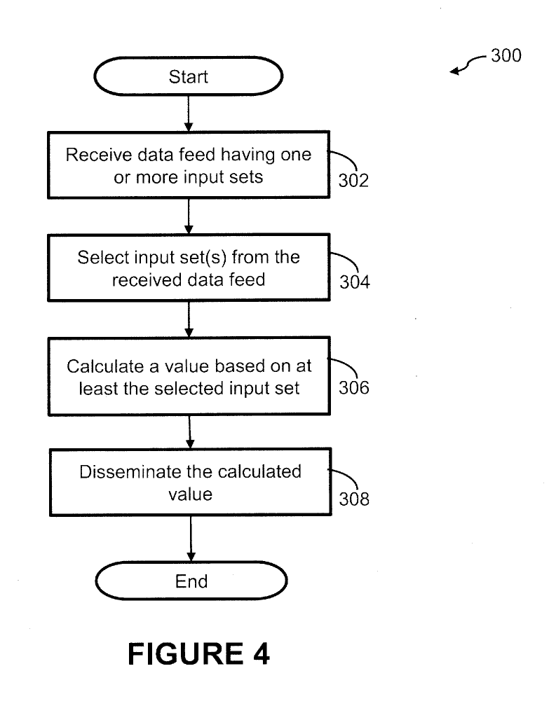

FIGS. 4-6 are flow diagrams that depict functions that may be included in or performed by the trading system to facilitate implementation of the methods described herein. The methods may be used with financial trading system 100, and may be performed by one or more components of the financial trading system 100. For purposes of illustration, the methods in FIGS. 3-5 are described as being implemented by a computing device (such as computing device 200 in FIG. 2 or calculation engine 112 in FIG. 1); however, other examples are also contemplated. According to embodiments, the steps depicted in FIGS. 4-6 can be carried out using proprietary software as described herein.

While the methods described herein illustrate a number of blocks that are in a sequential order, these blocks may also be performed in parallel or in a different order than those described herein. Also, the various blocks may be combined into fewer blocks, or divided into additional blocks. In addition, it should be understood that the flow diagrams show functionality and operation of possible implementations of the present embodiments, though other implementations are also contemplated. Moreover, each block in the flow diagrams may represent a module, a segment, or a portion of program code that includes one or more instructions executable by a processor for implementing specific logical functions or steps in the process. The program code may be stored on data storage (such as data storage 206).

FIG. 4 is a flow diagram that depicts functions that may be included in the trading platform 104 to facilitate implementation of the methods described herein. According to an embodiment, at step 302, the calculation engine 112 receives one or more data feeds and identifies one or more input sets from within the one or more data feeds. According to this embodiment, these input sets are routed to the calculation engine 112 from the matching engine 108. According to another embodiment, other portions of an exchange's trading system could receive the one or more data feeds having one or more input sets and route the input sets to calculation engine 112. Additionally, according to embodiments, the one or more data feeds having one or more input sets could be generated within the trading platform 104 or could be received at the trading platform 104.

The received data feeds may include input sets related to the trading of financial products. According to an embodiment, the input sets in the received data feed(s) include, but are not limited to, the symbol, expiration, strike price, and opening price. According to other embodiments, the input sets may include: information related to the liquidity of a financial product; day of week the input set expires; quote width of the a financial product; strike range span; the number of series listed to for a financial product if the product was a derivative; information related to open interest in a financial product; and/or information related to the robustness or quality of information available for a financial product.

According to an embodiment, the input sets in the received data feed(s) pertain to a single financial product (e.g., options contracts having the same expiration date and the same underlying asset). According to other embodiments, the input sets contained in the received data feed(s) pertain to multiple different financial products (e.g., option contracts having the different expiration dates and the same underlying asset, option contracts having different expiration dates and different underlying assets, and option contracts having the same expiration dates and different underlying assets). According to an embodiment, the input sets contained in the received data feed(s) pertain to option contracts having the same underlying assets, different expiration dates, and different expiration intervals (e.g., option contracts expiring daily, weekly, monthly, quarterly, yearly, or some other set duration of time).

At step 304, an input set(s) is selected from the received data feed(s). According to an embodiment, the selection at step 304 is performed by the calculation engine 112. According to another embodiment, another portion of the trading platform 104 or exchange system 102 performs the selection at step 304.

The calculation engine 112 may use all or part of the selected input set(s) to calculate a value. The calculated value may be an SOQ, a spot index, or any number of other values that may be calculated in whole or in part from the input set(s). The number of input set(s) and the determination of what input set(s) to use may vary based on the SOQ calculation being performed by the calculation engine 112. For example, when calculating an SOQ, if the SOQ of an index requires the use of a single input set, the calculation engine 112 can select a single input set for use in the SOQ calculation. In another instance of calculating an SOQ, the SOQ calculation may require or allow for multiple input set(s) to be used alone or in conjunction with one another for purposes of calculating the SOQ. When calculating a spot index with option prices, for example, the calculation engine 112 can select and use two or more input sets. The input sets used by the calculation engine 112 to calculate the spot index may be the same, a superset, or a subset of the input sets used to calculate the SOQ. In some instances, the input sets used to calculate the spot index may be completely different than the input sets used to calculate the SOQ. While an SOQ and spot index are described for illustrative purposes, it should be understood that the computing engine 112 can calculate any number of other values using the same or similar methodology.

As an example of calculating an SOQ, the calculation engine 112 may receive input set(s) that may be used to calculate the SOQ of a volatility calculation based on S&P 500 option contracts (i.e., options contracts that have the S&P 500 index as their underlying asset). The calculation engine 112 may use the selected input set(s) to calculate the SOQ according to the following formula:

$${σ}^{2} = \frac{2}{T} {\sum }_{i} \frac{Δ {K}_{i}}{{K}_{i}^{2}} {e}^{RT} Q ( {K}_{i} ) - {\frac{1}{T} [ \frac{F}{{K}_{0}} - 1 ]}^{2}$$

### Where:

T is a time to expiration;

F is a forward index level;

Kᵢ is a strike price of i^{th} out-of-the-money option (a call is Kᵢ>F and a put if Kᵢ<F);

ΔKᵢ is an interval between strike prices;

K₀ is a first strike below the forward index level, F;

R is a risk-free interest rate to expiration; and

Q(Kᵢ) is a midpoint of a bid-ask spread for each option with strike Kᵢ.

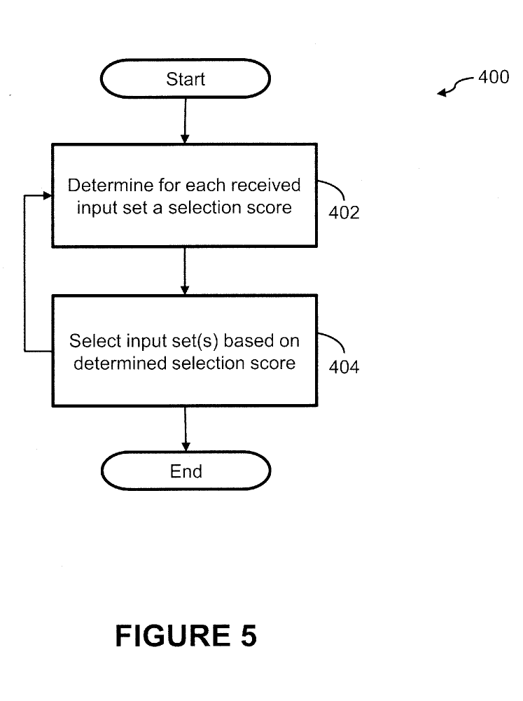

The calculation engine 112 may select a single set from the data feed that would pertain to options having a time to expiration equal to T. For example, if T was defined to be 9 calendar days (according to embodiments T may be defined as any number), and the received data feed included input sets pertaining to S&P 500 option contracts having different durations (e.g., option contracts that measure returns on an underlying asset over daily, weekly, monthly, quarterly, yearly, or some other set duration of time) and different times to expiration (e.g., weekly S&P 500 option series contracts time to expiration=16 calendar days, monthly S&P 500 option series contracts time to expiration=9 calendar days, and quarterly S&P 500 option series contracts time to expiration=19 calendar days), the single input set used in calculating the SOQ would be that which pertains to monthly S&P 500 option contracts because their time to expiration is equal to T. According to another embodiment, an SOQ requiring the use of n input sets may result in the selection of n input sets. The selection of input set(s) is further described in FIGS. 4 and 5, and in the accompanying description.

In another example, the calculation engine 112 may calculate a spot index using two or more selected input sets, wherein the selected input sets may be the same or different than the selected input sets that are used to calculate the SOQ in the above example. The calculation engine 112 may use the selected input sets to calculate the spot index according to the following formulas:

$${σ}_{1}^{2} = \frac{2}{{T}_{1}} {\sum }_{i} \frac{Δ {K}_{i}}{{K}_{i}^{2}} {e}^{{RT}_{1}} Q ( {K}_{i} ) - {\frac{1}{{T}_{1}} [ \frac{{F}_{1}}{{K}_{0}} - 1 ]}^{2}$$

$${σ}_{2}^{2} = \frac{2}{{T}_{2}} {\sum }_{i} \frac{Δ {K}_{i}}{{K}_{i}^{2}} {e}^{{RT}_{2}} Q ( {K}_{i} ) - {\frac{1}{{T}_{2}} [ \frac{{F}_{2}}{{K}_{0}} - 1 ]}^{2}$$

### Where:

σ²₁ is a near term option;

σ²₂ is a next term option;

T₁ is a time to expiration for a near term option;

T₂ is a time to expiration for a next term option;

F is a forward index level;

Kᵢ is a strike price of i^{th} out-of-the-money option (a call is Kᵢ>F and a put if Kᵢ<F);

ΔKᵢ is an interval between strike prices;

K₀ is a first strike below the forward index level, F;

R is a risk-free interest rate to expiration; and

Q(Kᵢ) is a midpoint of a bid-ask spread for each option with strike Kᵢ.

The calculation engine 112 may select two or more sets from the data feed, wherein a first input set would pertain to near term options having a time to expiration equal to T₁ and a second input set would pertain to next term options having a time to expiration equal to T₂. For instance, if a spot index was being calculated at 12 days (according to embodiments, the number of days may be predefined as any numbers and may represented as calendar days, business days, or in another form), and the received data feed included input sets pertaining to S&P 500 option contracts having different durations (e.g., option contracts that measure returns on an underlying asset over daily, weekly, monthly, quarterly yearly, or some other set duration of time) and different times to expiration (e.g., weekly S&P 500 option series contracts time to expiration=16 days, monthly S&P 500 option series contracts time to expiration=9 days, and quarterly S&P 500 option series contracts time to expiration=19 days), the input sets used in calculating the spot index would be those that pertain to a monthly S&P option contract and a weekly S&P 500 option contract because the monthly time to expiration (T₁) occurs closest before the point in time for which the spot index is being calculated and the weekly time to expiration (T₂) occurs closest after the point in time for which the spot index is being calculated. According to another embodiment, a spot index requiring the use of n input sets may result in the selection of n input sets. The selection of input sets is further described in FIGS. 4 and 5, and in the accompanying description.

It is important to note that the input set(s) selected at step 304 may not be constant. Rather, the input set(s) may change between implementations. This may be due, in part, to the dynamic nature of trading, the amount of data being processed, the change and the rate at which the data must be processed to facilitate trading. Moreover, the input sets can be selected dynamically between implementations such that a first set of input sets may be selected in a first implementation and a second set of input sets may be selected in a second implementation, wherein both the first set and the second set may be independently used in the calculation of the same SOQ, spot index, and/or other value. For instance, at another point in time, the weekly S&P 500 option contracts time to expiration may equal 9 days. At that point in time, the input set for the weekly and not the monthly S&P 500 option series contracts may be selected to determine the SOQ. Similarly, with respect to the spot index, the quarterly S&P 500 option series contracts time to expiration may equal 15 days. In such an example, the input sets for the monthly and the quarterly option series contracts may be selected to determine the spot index. This allows the calculation engine 112 to use interpolation between the near term monthly option series contracts and next term quarterly option series contracts, and to minimize or eliminate extrapolation.

At step 306, the calculation engine 112 calculates the value based on at least the selected input set(s). For example, if the value to be calculated is the SOQ for volatility calculation based on S&P 500 option contracts, as described above, the selected input set would be the monthly S&P 500 option contracts having a time to expiration of 9 days. The input set would include, for example, opening prices (e.g., bid and offer pairs and traded prices) for the at and out-of-the-money monthly S&P 500 options series contracts. Alternatively or additionally, the input sets can include traded prices for the at and out-of-the-money monthly S&P 500 options series contracts. The determination of whether to use opening prices and/or traded prices may be performed by the calculation engine 112. The calculation engine 112 may use the opening prices and/or the traded prices to determine F, ΔKᵢ, K₀, and Q(Kᵢ).

In an example where the value to be calculated is the spot index for the volatility calculation based on S&P 500 option contracts, the selected input set would be the monthly S&P 500 option contracts having a time to expiration of 9 days and the weekly S&P 500 option contracts having a time to expiration of 16 days. These input sets may be used to calculate F, ΔKᵢ, K₀, and Q(Kᵢ).

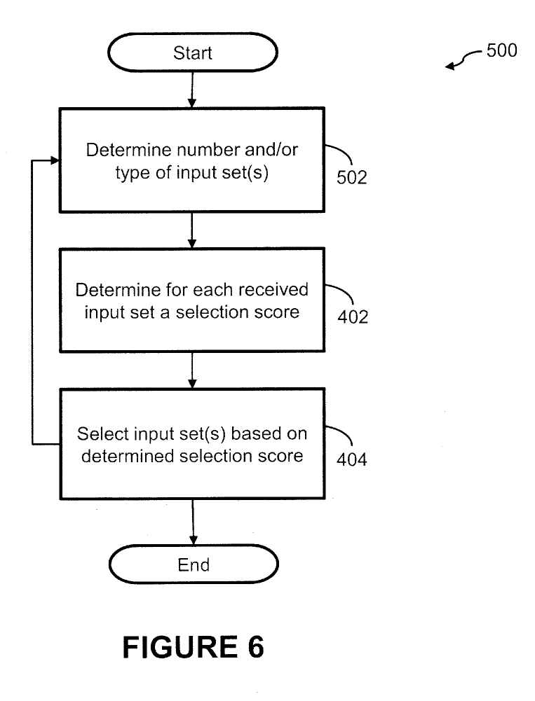

At step 308, the calculated value is disseminated, via the data output engine 114, to market participants and to other financial entities, such as the clearing corporation 118. According to another embodiment, the calculated value may be disseminated via some other portion of the trading platform 104 or exchange systems 102. According to yet another embodiment, the trading platform 104 or the exchange system 102 used to disseminate the calculated value may include technological system capabilities to simultaneously disseminate the calculated value to a broad range of market participants. Though described in the context of a single calculation, it should be understood that the processes in FIG. 4 (as well as FIGS. 5 and 6) are performed in short intervals (e.g., 1, 5, 10, or 15 second intervals). Accordingly, the systems and methods described herein must perform numerous fast and accurate calculations each day while maintaining a high level of quality so as to minimize risk to the financial markets.

FIG. 5 is a flow diagram that provides additional detail for step 304, as shown in FIG. 4 and described above. According to an embodiment, FIG. 5 shows the steps taken when selecting a single input set from one or more received input sets.

At step 402, a selection score is determined for each received input set. The selection score may be determined at the calculation engine 112. Alternatively, the selection score may be determined at one or more other points within either the exchange systems 102 or the trading platform 104.

The calculation engine 112 (or other component) may associate a selection score with one or more of the input sets. The selection score may be a binary operator, such as a 0 or 1, null or not null, etc. However, a non-binary operator may also be used. In some embodiments, the selection score may vary based on the value to be calculated, the received input sets, etc. For example, the SOQ to be calculated may be associated with one or more selection inputs that must or should be used to calculate the SOQ. In such examples, a higher weight may be applied to those selection inputs. For instance, the SOQ to be calculated may be for a volatility calculation based on S&P 500 option contracts having a time to expiration of 9 days. Examples of input sets for this SOQ calculation may include weekly, monthly, and quarterly values. The scores for each of these values may be represented in Table 1, wherein the input set having a time to expiration closest to the defined T may be given a higher weight or score than those input sets that have times expiring too far or too near in time.

TABLE 1

| | | Time to | |
|---|---|---|---|
| Expiration | | Expiration for | Selection |
| Intervals | Defined T | the Input Set | Score |
| Weekly | 9 days | 16 days | 0 |
| Monthly | 9 days | 9 days | 1 |
| Quarterly | 9 days | 19 days | 0 |

At step 404, the input set is selected based on the determined selection score. For example, in Table 1, the monthly input group is selected because it has the highest score. According to another embodiment, the selection process could be structured such that the input group with the lowest score is selected.

According to other embodiments, the selection score may be a sum, average, or other mathematically derived score or various sub-scores that are related to factors of the input set. One instance where a derived score may be used is to break a tie should the first factor result in two or more input sets having the same selection score. For instance, in the example described above, multiple input sets may have a time to expiration of 9 days. This may occur, for example, when there is both an AM and PM settled monthly options contract series. In such examples, multiple input sets having the same input score may occur, as shown in Table 2.

TABLE 2

| | | Time to | |
|---|---|---|---|
| Expiration | | Expiration for | Selection |
| Intervals | Defined T | the Input Set | Score |
| Weekly | 9 days | 16 days | 0 |
| AM-Monthly | 9 days | 9 days | 1 |
| PM-Monthly | 9 days | 9 days | 1 |
| Quarterly | 9 days | 19 days | 0 |

According to the example in Table 2, both AM and PM monthly contracts have a selection score of 1. In order to determine what input set to select, an additional factor (such as liquidity) could be considered. According to an embodiment, liquidity is determined by the volume of the option series in the previous month prior to the listing of the current contract series. This additional factor is shown in Table 3 along with the final selection score, which is calculated at step 402 by summing the time to expiration score and the liquidity score:

TABLE 3

| | | Time to | Time to | | Selec- |
|---|---|---|---|---|---|
| Expiration | Defined | Expiration for | expiration | Liquidity | tion |
| Intervals | T | the Input Set | Score | Score | Score |
| Weekly | 9 days | 16 days | 0 | 0 | 0 |
| AM-Monthly | 9 days | 9 days | 1 | 1 | 2 |
| PM-Monthly | 9 days | 9 days | 1 | 0 | 1 |
| Quarterly | 9 days | 19 days | 0 | 0 | 0 |

In this example, at step 404, the AM monthly input set is selected because it has the highest selection score.

Steps 402 and 404 are performed each time an SOQ is calculated. For example, at a first point in time, a first SOQ will be calculated based on one or more selected input sets (per step 402 and 404). At a second point in time, the same or different SOQ will need to be calculated. Rather than use the selected input sets from the first SOQ, the calculation engine may iterate steps 402 and 404 to select new input sets for calculation of the SOQ. The new input sets may include one or more of the input sets used to calculate the first SOQ. Accordingly, the selection process may occur every time there is an SOQ calculation, regardless of whether the SOQ had been previously calculated.

In another example, the calculation engine 112 may calculate a spot index by applying weights, time to expiration scores, liquidity scores, selection scores, etc. in a manner similar to that described above in reference to calculation of the SOQ. Table 4 illustrates input sets having varying times to expiration, expiration scores, liquidity scores, and selection scores.

TABLE 4

| | | Time to | Time to | Day of Week | | |
|---|---|---|---|---|---|---|
| Expiration | Time for | Expiration for | Expiration | Expiration | Liquidity | Selection |
| Intervals | Spot index | the Input Set | Score | Score | Score | Score |
| Weekly | 12 days | 2 days | 0 | 1 | 0 | 1 |
| Weekly | 12 days | 16 days | 1 | 1 | 0 | 2 |
| AM- | 12 days | 9 days | 1 | 1 | 1 | 3 |
| Monthly | | | | | | |
| PM- | 12 days | 9 days | 1 | 1 | 0 | 2 |
| Monthly | | | | | | |
| Quarterly | 12 days | 18 days | 0 | 0 | 0 | 0 |
| Weekly | 12 days | 12 days | 1 | 0 | 0 | 1 |

To calculate a spot index, the calculation engine 112 can use two or more input sets. In embodiments, the input sets having the closest near term options and the closets next term options in relation to the point in time for which the spot index is calculated may be given a higher selection score. A day of week expiration score may also be determined for one or more of the input sets. A relatively higher day of week expiration score may be associated with input sets that are set to expire on a specific day of the week, month, quarter, year, etc. For example, a higher day of week expiration score may be associated with input sets that expire on the last trading day of the week; however, other examples are also contemplated. A liquidity score, as well as one or more additional factors, may also be determined and used to calculate the selection score.

Although Table 4 illustrates one or more types of scores (e.g., the time to expiration score, day of week expiration score, and liquidity score) as having the same weight in determining the selection score, it should be understood that one or more types of scores may be given different weights such that a first type of score is comparatively more influential than a second type of score when calculating a spot index. Further, a minimum score may be required before a type of score may be used as a valid input set. For example, if a spot index is to be calculated using input sets that expire on the last trading day of the week then those input sets that do not expire on the last trading day of the week may be represented with a value that makes the input set an invalid input set for calculation purposes. Thus, for instance, input sets in Table 4 having a day of week expiration score of 0 may represent invalid input sets that may not be used when calculating the spot index. In contrast, those input sets having day of week expiration scores greater than 0 may be considered valid input sets that may be used to calculate the spot index. While described in the context of the day of week expiration score, it should be understood that any one or more types of scores may be weighted and/or have associated indicators of validity that may be considered alone or in combination with one another when determining the spot index.

According to the example in Table 4, the point in time which the spot index is being calculated is 12 days. The closest time to expiration for near term options is the AM-Monthly and/or the PM-Monthly at nine days. Further, the closest time to expiration for next term options is the Weekly at 16 days. Accordingly, the AM-Monthly and PM-Monthly at nine days and the Weekly at 16 days have a time to expiration score that is higher than those expiration times that are farther from the point in time for which the spot index is calculated. The higher time to expiration score may influence the selection score when the calculation engine 112 selects the two or more input sets to calculate the spot index.

While specific examples have been described above, it should be understood that any number of factors can be used to determine the selection score. For example, the calculation engine 112 may determine the selection score using one or more of the following factors: information related to the liquidity of a financial product; quote width of the a financial product; strike range span; the number of series listed to for a financial product if the product was a derivative; information related to open interest in a financial product; and/or information related to the robustness or quality of information available for a financial product. Other factors are also contemplated.

Moreover, in the event that multiple input sets have the same selection score, the calculation engine 112 may use a tie-breaker (or series of tie-breakers) to select one or more input sets from the multiple input sets that have the same selection score. In one instance, the tie-breaker process may give preference to a weight, expiration score, liquidity score, etc. used to calculate the selection score. In another instance, the tie-breaker process may include a request for feedback from a user or engine, which may input or otherwise select one or more input sets from the multiple input sets that have the same selection score. In yet another instance, the one or more input sets may be selected from the multiple input sets at random or according to a predetermined set of rules that are carried out by hardware, firmware, and/or software logic. Other instances are also contemplated.

FIG. 6 is another flow diagram that provides additional detail for step 304, as shown in FIG. 4 and described above. At step 502, the number and/or type of input set(s) required for the calculation is determined. The number of input sets for the SOQ calculation may be determined based on how many input sets are allowed or required for the calculation. In some embodiments, this determination may be performed by a database lookup or upon receipt of data that may identify a number of input sets for the calculation. For instance, the calculation engine 112 may perform a database lookup and determine that an SOQ calculation only requires a single input set based on the variables and/or other parameters used in the SOQ calculation. In another instance, however, the calculation engine 112 may determine that more than one input set should be used for the SOQ calculation. In yet another instance, the calculation engine 112 may determine that a spot index calculation requires two or more input sets. The number of input sets required for the SOQ calculation may be stored in a database (such as data storage 206 in FIG. 2) along with other information that may be used to calculate the SOQ, spot index, or other value.

The calculation engine 112 may also determine the type of input set required for the SOQ, spot index, or other calculation. This determination may be performed by a database lookup or upon receipt of data that may identify the type of input set required for the SOQ, spot index, or other calculation. The type of input set may be simple input sets or complex input sets. Simple input sets may include information regarding a single options contract series (e.g., monthly AM settled S&P 500 option series contracts that have a time to expiration of 9 days). Complex input sets may include information derived from multiple simple input sets. For example, a complex input set could be the average opening price of a particular group of option series contracts, e.g., a sector. In some instances, the calculation engine may receive the complex input set via one or more other components in the trading platform 104 or exchanges systems 102. In other instances, however, the calculation engine may calculate the complex input set based on one or more simple input sets (e.g., one or more of the input sets that received a selection score at step 402). In the event that the calculation engine 112 is used to calculate a complex input set, a weighting scheme may be used in that calculation. The type of input set may be stored in a database (such as data storage 206 in FIG. 2) along with other information that may be used to calculate the SOQ, spot index, or other value.

In a similar manner to that described above, the calculation engine 112 may determine additional information that may be used to calculate the SOQ, spot index, or other value. This information may include, for example, what input sets should be given a selection score. This information may be stored in a database (such as data storage 206 in FIG. 2) along with other information that may be used to calculate the SOQ, spot index, or other value.

At step 402, as discussed above, a selection score is assigned to each input set, simple and complex alike. At step 404, as described above, the input set(s) is selected based on the determined selection score.

Steps 502, 402, and 404 are performed each time a value is calculated. For example, at a first point in time, a first index value will be calculated based on one or more selected input sets (per steps 502, 402, and 404). At a second point in time, the same or different index value will need to be calculated. Rather than use the selected input sets from the first index value, the calculation engine may iterate steps 502, 402, and 404 to select new input sets for calculation of the index value. The new input sets may include one or more of the input sets used to calculate the first index value. Accordingly, the selection process may occur every time there is an index value calculation, regardless of whether the index value had been previously calculated.

In another example, steps 502, 402, and 404 are performed each time a spot index is calculated. For instance, a first spot index is calculated at a first point in time while a second spot index is calculated at a second point in time. The two or more input sets used to calculate the first spot index and the second spot index may vary such that a new selection process is needed each time a new spot index is calculated.

According to an embodiment, if an SOQ, spot index, or calculation calls for one complex input set that is to be calculated by the calculation engine 112 based on simple input sets chosen using the selection scores determined at step 402, the additional steps described below can be used by the trading platform 104.

First, the definition of the complex input set may be determined. According to an embodiment, this definition could be contained in an electronic database. For example, a complex input set could be an equally weighted combination of the three options series contracts from the information technology sector that having the highest selection scores.

Second, at step 404, the selection scores for the simple input sets are determined. Third, based on the determined selection scores and the complex input set definition, the complex input set is generated by the calculation engine 112. Fourth, at step 404, the complex input set is selected based on its null/not null selection score.

According to other embodiments, the SOQ, spot index, or other calculation could require any number of simple or complex (pre- or dynamically calculated) input sets.

FIG. 6 is a timeline that depicts contract expiration dates according to embodiments described herein. As illustrated, FIG. 6 includes expiration dates A, B, C, D, D′, and E. The expiration dates may correspond to a variety of contract types. For instance, expiration dates A and D may correspond to monthly contracts that expire on the same day each month (e.g., the third Friday of each month). Expiration date C may correspond to contracts that expire on a quarterly, yearly, or other duration. Expiration dates B and E may correspond to short-term contracts that expire on a weekly basis or according to another period of time that is less than a monthly contract. Expiration date D′ may correspond to a flexible contract expiration date, such as an expiration date that is defined by one or more market participants. While the time interval between expiration dates is generally regular in nature (e.g., weekly, monthly, quarterly, etc.), examples exist where the time interval between expiration dates may vary (e.g., due to exchange holidays or other design reasons). Further, while there is generally a regular time interval between the calculation of settlement values, there exist instances where the time interval between the calculation of settlement values can vary (e.g., due to a natural disaster, governmental action, or other event). In such events, the calculation of one or more settlement values may be adjusted to account for variations in one or more times to expiration.

The systems and methods described herein may be used to determine the spot index at time S. The processes of determining the spot index may include the calculation engine 112 (or other device or processing component) receiving a data feed, selecting two or more input sets from the data feed, and calculating a spot index based at least in part on the two or more selected input sets. The selection of the input sets may be based on, among other factors, the expiration date of the option contracts in the input sets. In embodiments, the calculation engine 112 may select input sets that represent the near term options and next term options that are closest to time S, and use the selected input sets to interpolate the spot index at time S. In embodiments where the closest near term options and/or next term options cannot be selected, the calculation engine may select near term options and/or next term options that minimize the extrapolation needed to estimate the spot index at time S.

For example, the calculation engine may receive a data feed having a number of input sets including input sets associated with regular monthly options A and D, regular quarterly options C, regular weekly options B and E, and flexible options D′. The calculation engine 112 may identify two or more input sets (such as input sets A and C, A and D, B and C, B and D, B and D′, etc.) that may be used to calculate the spot index at time S. Of the identified input sets, the calculation engine 112 may determine that calculating the spot index at time S using two monthly input sets A and D would require extrapolation. However, varying the contract types to include a combination of weekly and quarterly expirations (such as weekly options B and quarterly options C) may allow the calculation engine 112 to use a more accurate interpolation method to calculate the spot index at time S.

The calculation engine 112 may take into account a number of factors when determining whether to use input sets that allow for extrapolation or input sets that require interpolation. For example, the calculation engine 112 may determine whether one or more of the input sets are valid. The validity of an input set may be determined based on one or more of the types of scores described in reference to Table 4, one or more rules for calculating the spot index, one or more weights associated with one or more of the input sets, etc. For instance, if the day of week expiration score for quarterly options C does not fall on the last trading day of the week then the input set for quarterly options C may not be a valid set. Accordingly, rather than use an interpolation method that utilizes the valid weekly options B and invalid quarterly options C, the calculation engine 112 may select a different combination of input sets, such as weekly options B and monthly options D, that would minimize the extrapolation required to calculate the spot index at time S.

In another example, the calculation engine 112 may determine that the combination of regular weekly options B and regular monthly options D is not a viable combination (e.g., because of planned or unplanned settlement issues with monthly options D). In such instances, the calculation engine 112 may then determine that the amount of extrapolation required for the combination of regular weekly options B and flexible options D′ is less than the extrapolation required for the combination of regular monthly options A and monthly options D and/or the extrapolation of regular weekly options B and E. Accordingly, the calculation engine 112 may select the combination of regular weekly contract B and flexible options D′ because the combination would allow for a more accurate, viable, calculation of the spot index at time S.

It should be understood that arrangements described herein are for purposes of example only. As such, those skilled in the art will appreciate that other arrangements and other elements (e.g., machines, interfaces, functions, orders, groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

What is claimed is:

1. A system configured to determine settlement values of derivative investment instruments representative of a state of market volatility, the system comprising:
a communication interface configured for communication with at least external one data source remotely located from the system via a network;
at least one data storage device storing data received via the communication interface, the received data corresponding to price and expiration information for a plurality of financial instruments predetermined as suitable as underlying assets for derivative investment instruments representative of the state of market volatility, wherein the plurality of financial instruments define one or more input sets, each input set comprising options contracts having a same underlying asset, different expiration dates and different expiration intervals;
an order matching engine having a processor configured to receive a plurality of contra-position bids and offers and pair up the received contra-position bids and offers to complete trades between the paired received contra-position bids and offers;
a settlement value processor in communication with the at least one data storage device and the order matching engine; and
a program logic memory in communication with the settlement value processor and storing program instructions, the settlement value processor operative to execute the program instructions to:
receive a plurality of input sets from the at least one data storage device or the order matching engine;
select a portion of the plurality of input sets based on a plurality of selection criteria, wherein one of the plurality of selection criteria comprises option contracts having expiration dates less than 30 days from a current day; and
generate a settlement value for the derivative investment instrument representative of the state of market volatility according to the settlement calculation relation:
$${σ}^{2} = \frac{2}{T} {\sum }_{i} \frac{Δ {K}_{i}}{{K}_{i}^{2}} {e}^{RT} Q ( {K}_{i} ) - {\frac{1}{T} [ \frac{F}{{K}_{0}} - 1 ]}^{2}$$
where:
T is a time to expiration;
F is a forward index level;
Kᵢ is a strike price of i^{th} out-of-the-money option—a call if Kᵢ>F and a put if Kᵢ<F;
ΔKᵢ is an interval between strike prices: ΔKᵢ is the interval between strike prices—half the distance between the strike on either side of Kᵢ:
$$Δ {K}_{i} = \frac{{K}_{i + 1} - {K}_{i - 1}}{2}$$
further where ^{Δ}K for a lowest strike is a difference between the lowest strike and a next higher strike; likewise, ^{Δ}K for a highest strike is a difference between the highest strike and a next lower strike;
K₀ is a first strike below the forward index level, F;
R is a risk-free interest rate to expiration; and
Q(Kᵢ) is a midpoint of a bid-ask spread for each option with strike Kᵢ; and
transmit a settlement value calculated according to the settlement calculation relation to a remote server.
